(19) United States
(12) Patent Application Publication
(10) Pub. No.: US 2018/0031260 A1
(43) Pub. Date: Feb. 1, 2018

(54) CONTROL UNIT FOR A HVAC SYSTEM COMPRISING A DISPLAY

(71) Applicant: OJ Electronics A/S, Sønderborg (DK)

(72) Inventors: Lars Kruse Bernbom, Nordborg (DK); Anker Bo Christensen, Broager (DK)

(21) Appl. No.: 15/549,907

(22) PCT Filed: Feb. 9, 2015
(86) PCT No.: PCT/EP2015/052636

§ 371 Date: Aug. 9, 2017

(51) Int. Cl. F24F 11/00; G05B 15/02

(52) U.S. Cl. CPC F24F 11/006; F24F 11/0086; G05B 15/02; F24F 2011/0063; F24F 2011/0068; F24F 2011/0091; G05B 2219/2614

(57) ABSTRACT

Disclosed herein is a method of communicating control unit data from a control unit of a HVAC system to a portable reading device, the control unit comprising a display, the method comprising; generating a code based on said control unit data, converting said code into a graphical layout, and providing said graphical layout via the display. Disclosed herein is also a control unit of a HVAC system comprising a display and a processing unit, said control unit is configured to communicate control unit data, wherein the processing unit is configured to perform said method and the display is configured to provide the graphical layout. The invention further relates to a method of obtaining control unit data with a portable reading device from a control unit of a HVAC system, the method comprising; scanning a graphical layout, generating a code based on the graphical layout, decoding the code by accessing a website, and obtaining the control unit data based on the decoded code.

### FIELD OF INVENTION

The invention relates to a control unit for a HVAC system comprising a display.

### BACKGROUND OF THE INVENTION

Control units are used in relation to HVAC (heating, ventilation and air conditioning) systems to control temperature and indoor air quality within a building or a room in a building or to control removal of snow and ice as well as patio heaters in an outdoor installation.

When controlling the temperature and indoor air quality in a room or rooms one or more control units within the room(s) are set to a predefined set point selected in relation to the desired room temperature and indoor air quality.

Today control units can be used to collect a extensive range of data which may be of the interest of the supplier in order to communicate potential changes in the pricing during the day in order to minimize peak loads on the energy supply network and the user in order to control the energy usage and obtain comfortable, optimal and economical use of the HVAC system as well as the installing contractor or other support functions in order to find out why the system is failing and to guide the user towards a optimal and economical use.

In order to use the data from the control unit optimally it is therefore desirable to make the data more accessible not only on site but also in order to bring the data with you to other locations e.g. in order to configuring other control units or for providing the information to other recipients. This such that the users, e.g. the owner of the control unit and an installation contractor, experience that the data is clearly laid out without experience any delay or distortions.

The object of the invention is thereby to communicate data from the control unit in an easy, fast, secure and reliable way.

### SUMMARY

An objective is achieved by a method of communicating control unit data from a control unit of a HVAC system to a portable reading device, the control unit comprising a display and the method comprising; generating a code based on said control unit data, converting said code into a graphical layout, and providing said graphical layout via the display.

The control unit can be connected to and controlling electrical and/or water based heating systems as well as other kinds of heating, ventilation and air condition systems based on input from environmental sensors.

The control unit may be connected to or may comprise any environmental sensors suitable to be use with the HVAC system the control unit is connected to and controlling.

The display may comprise any sort of screen such as a LED (light-emitting diodes) screen or a LCD (liquid-crystal display) screen, including segmented screens and a touch screen.

Control unit data may comprise any control unit data comprised in the control unit. Control unit data may be a specific selection of any control unit data comprised in the control unit.

In one embodiment of the invention, said generating comprises compressing and/or encrypting said control unit data. The code may thereby either or both contain compressed and encrypted control unit data.

The code containing the control unit data, can be a variable-length code consisting of a combination of numbers and letters whereon there is run a compression, e.g. Huffman coding, Lempel-Ziv coding or arithmetic coding which all are entropy encoding algorithms used for lossless data compression. Particular Huffman compression is simple, fast and uses short codes for values with higher probabilities. Hereafter the code may be interpreted into a graphical layout.

The advantage of a lossless compression is that the original and the decompressed data are identical.

The code may be identified as a first code as well as the graphical layout may be identified as a second code.

In this way an extensive range of data can be compressed in a way so that the data velocity lag and volume is kept to a minimum, a simple data safety is obtained and the user will not experience a long response time.

An objective is further achieved by a method of obtaining control unit data with a portable reading device from a control unit of a HVAC system, the method comprising; scanning a graphical layout, generating a code based on the graphical layout, decoding the code by accessing a website and obtaining the control unit data based on the decoded code.

The portable reading device comprises an imaging device such as a camera suitable for scanning the graphical layout. The portable reading device may include either or both of; a personal computer (including a laptop), and a mobile device such as a smart phone, tablet or Personal Digital Assistant

(PDA).

In one embodiment of the invention said decoding is performed by the website.

When scanning the graphical layout the portable reading device may link to a website via a browser and a wireless network. After entering the website the remaining content of the graphical layout is decoded through the website.

This enables that the current control unit data can be viewed on a website which may give a better overview of all the control unit data such as environmental, operational, historical and programming control unit data related to the installing, operation and use of a HVAC system. Such website may, through an email, be shown to a service or support department when the owner contacts them with any questions with regards to the use. Or such website may be used by the installation contractor when installing a HVAC system with more than one control unit or adds a control unit to an exciting HVAC system, in order to manually synchronies the control unit settings.

In one embodiment of the invention, the graphical layout comprises a QR code.

The graphical layout can be a QR code also known as a matrix barcode (or a two-dimensional barcode) obtained through the use of a QR code generator. This may be by means of a processing unit comprising or accessing the QR generator. The generated QR code can be a static QR code or a dynamic QR code.

In one embodiment of the invention, said control unit data comprises dynamic control unit data.

Control unit data can comprise both static and dynamic control unit data. Dynamic control unit data may be current and momentary control unit data such as any environmental control unit data metered by an environmental sensor and/or historical control unit data such as environmental control unit data metered by an environmental sensor over time, control unit uptimes and downtimes, power consumption over time and weekly overviews of use behaviors. Dynamic control unit data may thereby change as response to continues input, e.g. from an environmental sensor or from changes to the settings made by the user, by user here meant the owner. Static control unit data may be identifying control unit data and pre-settings from the manufacturer. Static control unit data may be non-changeable or change as responds to occasional input, e.g. from changes to the manufacturing settings made by the user, by user here meant an installing contractor.

In one embodiment of the invention, said control unit data comprises environmental, historical and/or operational control unit data.

Environmental, historical and/or operational control unit data may include control unit data incorporated into a usage report, such as energy usage and energy costs.

In one embodiment of the invention, said control unit data comprises control unit settings.

Control unit settings may both include user settings and pre-installed manufacturing settings.

Control unit settings may include; choice of language, program schedule, screen light intensity, software version, product number, type and number of HVAC units coupled to the control unit, temperature constraints, etc.

In one embodiment of the invention, said control unit settings is used to configure one or more control units with the same control unit settings.

This may be performed manually entering the decoded control unit settings directly into another control unit. Or if the control unit is connected to a server via a network, whereas a web service is provided via the server, manually entering the control unit settings into the control unit into a user account on the web service using a remote device or a portable reading device wherefrom the control unit settings is transmitted to other control units.

In one embodiment of the invention, said method further comprises converting said control unit data into a usage report.

Control unit data may be converted into a usage report simultaneous with or after decoding the code in the graphical layout scanned by the portable reading device. This may be done via a website configured therefore.

In one embodiment of the invention, the method further comprises obtaining regional data from a database via a server, and comparing said control unit data with the regional data.

The regional data may either be accessible for the user on the control unit or the website, so that the user can compare the control unit data with the regional data and/or regional data may be used by a web service or the website to compare the control unit data and suggest a more optimal and economical usage to the user.

An objective is further achieved by means of a control unit of a HVAC system comprising; a display and a processing unit, said control unit is configured to communicate control unit data, the control unit wherein the processing unit is configured to generate a code based on said control unit data, convert said code into a graphical layout, and provide said graphical layout via the display, and the display is configured to provide the graphical layout.

In one embodiment of the invention, said graphical layout comprises a QR code.

In one embodiment of the invention, said control unit data comprises dynamic control unit data.

In one embodiment of the invention, said control unit use the method of communicating control unit data from the control unit as described above.

An objective is further achieved by means of a system comprising; a control unit as described above, and a portable reading device configured to obtain control unit data form the control unit.

An objective is further achieved by means of a computer program comprising a computer program code which, when executed in a control unit of a HVAC system, causes the control unit to execute a method as described above.

An objective is further achieved by means of a HVAC system comprising; a control unit as described above, and a portable reading device configured to obtain control unit data form the control unit.

Throughout the description electrical floor heating working together with a temperature sensor is used as an example, but the control unit can also be used to control other kinds of heating, ventilation and air conditioning systems by means of any other environmental sensor(s).

### BRIEF DESCRIPTION OF DRAWINGS

FIG. 1 is schematic illustrating an embodiment of a control unit connected to and controlling an electrical floor heating system;

FIG. 2 is a front plan view of the control unit shown in FIGS. 1 and 5;

FIG. 3 is schematic illustrating an electronic architecture of an embodiment of the of the control unit;

FIG. 4 is a flowchart for a method of communicating control unit data from a control unit using a code interpreted into a graphical layout on the display.

FIG. 5 is schematic illustrating an embodiment of a control unit connected to and controlling an electrical floor heating system as well as communicating with a server.

### DETAILED DESCRIPTION

FIG. 1 shows in a schematic illustration an embodiment of a control unit 10 comprising a temperature sensor 60 (see FIG. 3) and connected to and controlling an electric floor heating system 1 in a room or building consisting of one or more floor heating zones 2. Each floor heating zone 2 can be connected to and controlled by one or more control units 10. The control unit 10 can be connected to the electrical floor heating system 1 by wires but may as well be connected using a wireless connection, or a combination of the two.

The control unit 10 comprises control unit data and a display 11 with a screen view comprising a graphical layout 23. In the presently-illustrated embodiment the graphical layout 23 is a QR code 26. The graphical layout 23 is configured for being scanned by a portable reading device 30 in order to transfer control unit data from the control unit 10 to the portable reading device 30 and to display the control unit data via the portable reading device 30.

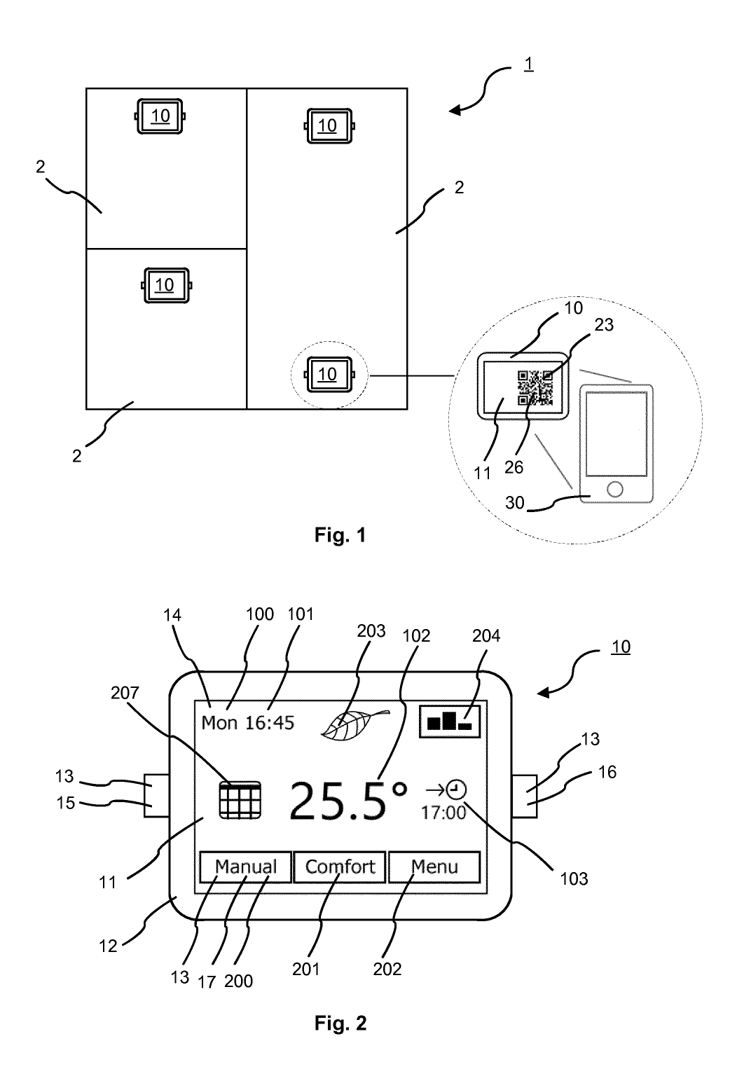

FIG. 2 shows a front plan view of the control unit 10 describing the control unit 10 in greater detail. The control unit 10 includes a housing 12, at least one input 13 adapted to receive user commands and at least one output 14 adapted for displaying control unit data such as environmental, operational, historical and programming control unit data related to the operation of the electrical floor heating system 1.

Input 13 can include one or more fixed-function hard keys 15, programmable soft keys 16, programmable touch screen keys 17, or any combination thereof. Output 14 can include any sort of display such as a LED (light-emitting diodes) screen or a LCD (liquid-crystal display) screen, including segmented screens. Output 14 and input 13 can be combined as a touch screen display 11. In the presently-illustrated embodiment, the control unit 10 includes a TFT LCD (thin-film-transistor liquid-crystal display) screen with a resistive pressure sensitive layer.

In the presently-illustrated embodiment, the control unit display 11 is configured to show a home screen containing at least output 14 as current weekday 100, current time 101, current temperature setting 102 and time for change in scheduled temperature setting 103.

In the presently-illustrated embodiment, the control unit display 11 is configured to show a home screen containing at least input 13 as a manual setting shortcut 200, comfort mode shortcut 201, a menu shortcut 202, an energy saving mode shortcut 203, an energy usage report shortcut 204 and a QR code shortcut 207.

In the presently-illustrated embodiment, the programmable soft key 16 is configured as a “quick” button for quick change between a home screen and/or a screen saving mode, to a comfort mode, frost mode, vacation mode and/or the like. And a hard key 15 is configured as a GFCI switch.

Control unit settings may both include user settings and pre-installed manufacturing settings. The control unit settings may be manipulated by the user in numerous ways allowing the user to customize the operation of the electrical floor heating system 1. This may include a comfort scheduling program, an energy saving scheduling program, a vacation override program and a frost override program.

The scheduling programs allow the user to customize the operation of the electrical floor heating system 1 according to a recurring weekly schedule. The weekly schedule allows the user to adjust set-points for different groups of days such as, but not limited to, “Work days” and “Home days” as well as different hours of the day that are typically organized into a number of different usage periods such as, but not limited to, “Wake up”, “Leave home”, “Come home” and “Go to sleep”.

The control unit 10 can also contain an energy usage program allowing the users to monitor and regulate their energy consumption (e.g., electricity use). Energy use program can include a real-time display of energy use, regular reports (hourly, daily, weekly, etc.), and provide estimates of projected costs.

The power consumption of the electrical floor heating system 1 may be measured within the control unit 10 or may be calculated from specifications of the electrical floor heating system 1, such as the size of each floor heating zone 2 in watt/m² or the energy consumption of each floor heating zone 2 in kWh entered into the control unit 10 and the uptime and downtime of the electrical floor heating system 1. Pricing information may be manually entered into the control unit 10. A usage report of the resent energy usage may be available through the control unit 10. If pricing information is not available, then only consumption data will be registered and reported.

FIG. 3 shows the internal components of the control unit 10 in greater detail. In the presently-illustrated embodiment the control unit 10 includes a temperature sensor 60, a processing unit 61, preferably a micro processer, a memory 62, a clock 64, preferably a real time clock, the display 11 and optionally a communication interface 65.

Processing unit 61 is configured to collect control unit data from the control unit 10 and encode the control unit data into a code. This by means of a memory unit 62 which the processing unit 61 use to run environmental programming, communications and store operation and configuration control unit data.

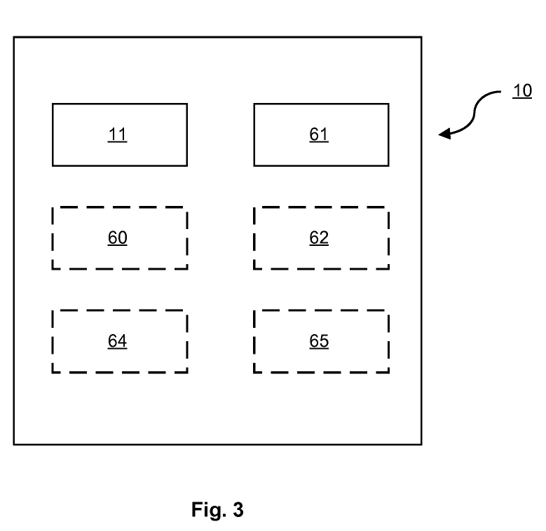

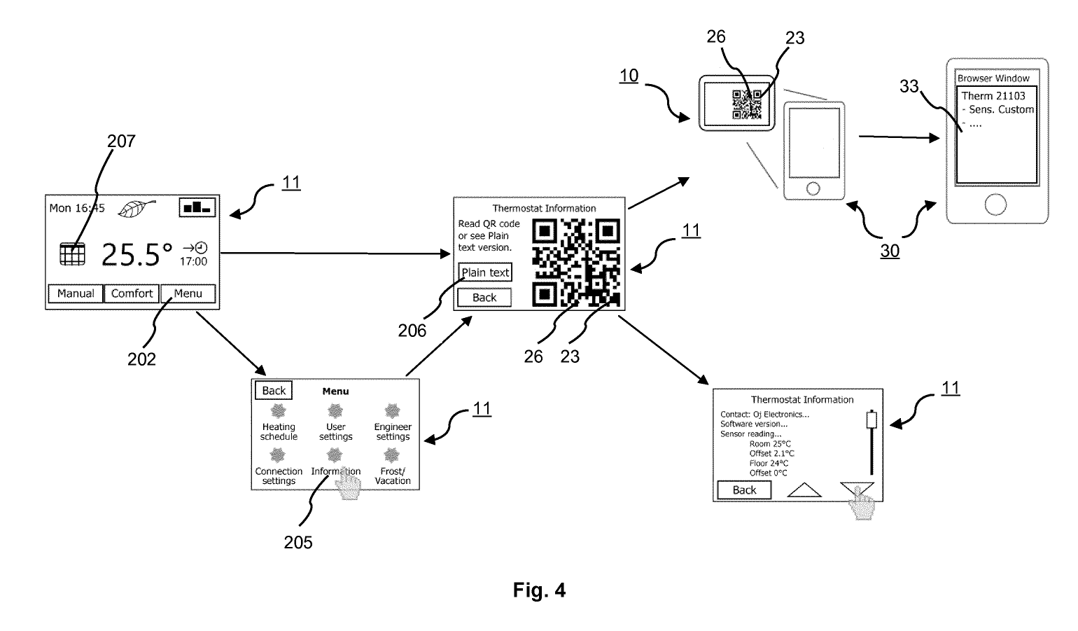

The code can be a variable-length code consisting of a combination of numbers and letters whereon there is run a compression, e.g. Huffman coding, Lempel-Ziv coding or arithmetic coding which all are entropy encoding algorithms used for lossless data compression. Particular Huffman compression is simple, fast and uses short codes for values with higher probabilities. Hereafter processing unit 61 interpreted or convert the code into a graphical layout 23 (see FIG. 4). The graphical layout 23 is in the presently-illustrated embodiment a QR code 26 obtained by using a QR code generator. The generated QR code 26 is then displayed on the control unit display 11. The generated QR code 26 can be a static QR code or a dynamic QR code.

Control unit data may in this way be easily accessed and transferred to a portable reading device 30 (see FIG. 4), e.g. a QR code reader, configured for scanning the QR code 26 and display the control unit data on a dedicated website 33 via a built-in browser in order to distribute and optimise control unit settings and optimize the technical support and/or the like.

The clock 64 within the control unit 10 may be automatically synchronised by a Frankfurt clock signal.

FIG. 4 shows a flowchart for a method of communicating control unit data, typical current control unit data, from a control unit 10 using a code interpreted or converted into a graphical layout 23 on the control unit display 11. Control unit data can be a selection from environmental, operational, historical and programming control unit data related to the operation of the electrical floor heating system 1.

In the presently-illustrated embodiment, starting from the home screen, the user either push the QR code shortcut 207 or the Menu shortcut 202 wherein the user pushes the Information button 205 both activating an internal digital process within the processing unit 61 (see FIG. 3) in the control unit 10 converting the control unit data into a QR code 26. As the QR code 26 may include dynamic control unit data a new QR code 26 is generated every time pushing the QR code shortcut 207 or the Information button 205. The user now has the option of reading the content of the QR code 26 by using a portable reading device 30. This by means of an imaging device and an application comprised in the portable reading device 30 configured for scanning the QR code 26. Then the portable reading device 30 links to a website 33 via a browser and a wireless network and the further content of the QR code 26 is decoded on the website 33 enabling control unit data to be displayed on the portable reading device 30. The control unit data can be current and momentary control unit data. The control unit data can also comprise both static and dynamic control unit data, whereas dynamic control unit data in the presently-illustrated embodiment will comprise control unit data from the temperature sensor 60 and the clock 64. The portable reading device 30 may be adapted to be located remote from the control unit 10 and can include either or both of; a personal computer (most typical a laptop computer), and a mobile device such as a smart phone, tablet or Personal Digital Assistant (PDA).

As an alternative to using the QR code 26 the user may use the Plain text button 206 to read the same control unit data which is contained in the QR code 26 in plain text on the control unit display 11.

The portable reading device 30 may be enabled to link to a website 33 where the control unit data can be read out and understood. The website 33 may be own and maintained through a manufacture server, an OEM server and/or a server owned by another separate organisation or enterprise. This giving the opportunity of presenting the control unit data in a practical, clear and easy understandable way. The user can then forward the content of the website 33 by copying the link of the website 33 into an email, or by printing the content on paper or sharing the link on other media.

The content of the QR code 26 may be programming control unit data such as control unit settings used to have other control units 10 configured with the same control unit settings. This by manually entering the control unit settings from the list directly into another control unit 10.

The content of the QR code 26 may be control unit identification, operation and/or programming control unit data used to receive optimal on-site and/or remote technical support from installer, manufacture, OEM or the like. This either by the user forwarding the content of the QR code 26 in an email as a link, as printed paper or share it on other media or by the support personal reads the QR code 26 on-site.

The content of the QR code 26 may be programmable control unit data such as control unit settings used by the user to see whether the settings supports the comfort the user want as well as for sharing the control unit settings with other users (e.g., friends and family).

The content of the QR code 26 may be historical control unit data used for a usage report. This in order to inform the user of the energy usage of the floor heating zone 2 controlled by the control unit 10 and giving advice on optimisation. The optimisation may include suggestion for control unit settings of one or more of the schedule comfort program, schedule energy saving program and/or any other program in the control unit 10. The relevant control unit setting might in particular include preheating, pre-cooling, open window detection and night-time reduction. Thereby instructing the user in how energy can be saved. The website 33 may enable the user to compare control unit data from the control unit 10 with regional data. The regional data may be supplied to the website 33 from a server having a database containing said regional data.

The content of the QR code 26 may be operational control unit data used for configuring the control unit 10 such that the installation of the control unit 10 and the electrical floor heating system 1 works, i.e. that the electrical floor heating system 1 heats when it is expected, that the temperature sensor 60 (see FIG. 3) is correctly installed and that a potential alarm system works as expected. These control unit data may also be used for fault detection.

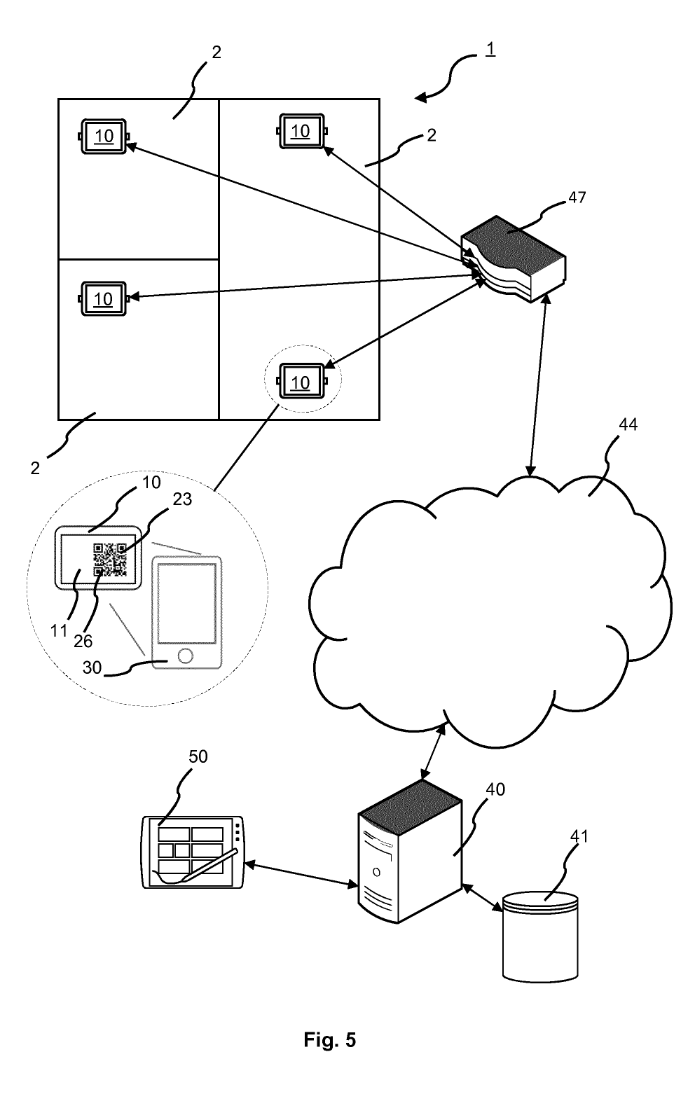

In addition and as shown in FIG. 5 the control unit 10 may comprise a communication interface 65 which in the presently-illustrated embodiment is, but not limited to, a WLAN module (see FIG. 3) so the control unit 10 can communicate with a server 40 or servers via a network 44 as well as at least one remote device 50 through the server 40. The remote device 50 may be the same device as the portable reading device 30. Network 44 can include different, interconnected networks such as a private network (often a private Wi-Fi network) in communication with the public Internet. The communication between the control unit 10 and the server 40 can be continually or periodically.

In the presently-illustrated embodiment, the control unit 10 is configured to communicate with a server 40 which may be a manufacture server, an OEM server and/or a server owned by another separate organisation or enterprise wherefrom there is provided a web service for registered users (typically the user who owns the control unit 10). It may be through the same server both the web service and the website is provided. Web service is able to log control unit data from the control unit 10, e.g. through a router 47 whereas the logged control unit data can be stored in the web services own database 41. Furthermore the web service allows the control unit 10 to communicate with remote devices 50 (e.g., personal computers and mobile devices). Control unit data can be a selection from environmental, operational, historical and programming control unit data related to the operation of the electrical floor heating system 1. Web service may also transfer regional data from the web services own database 41 to the control unit 10 and to remote devices 50. Regional data comprises logged control unit data retrieved from control units 10 connected to and using the web service. In one embodiment the regional data is from the same geographical region as the control unit 10 is located within. The web service may also be operable to provide remote software updates to the control unit 10 over network 44.

Through the web service one or more control units 10 may be coupled to a user account which has access to the control unit data of the one or more control units 10 and gives the opportunity of controlling the one or more control units 10 and changing programming control unit data such as control unit settings from a remote device 50 as well as copying control unit data from one control unit 10 to another control unit 10. Control unit settings may both include user settings and pre-installed manufacturing settings. User account may also contain histograms or the like of the logged control unit data e.g. showing energy usage.

Whereas a usage report of the resent energy usage may be available through the control unit 10, a long term usage report as well as usage report across one or more control units 10 connected to a user account may be available through the web service by login to the user account from a remote device 50.

A clock 64 (see FIG. 3) within the control unit 10 may in the presently-illustrated embodiment be automatically synchronised through the web service allowing the user to synchronise the one or more control units 10 connected to a user account with each other and/or with a timeserver connected to the web service through the network 44.

Registration of and login to the user account may be based on an email address. A control unit 10 can be connected to a user account by first connecting the control unit 10 to the network 40, e.g. a private Wi-Fi network, then entering the control unit name, identification number or the like followed by entering an email address. All three steps may be done through the control unit display 11. An automatic generated email with an activation link may then following be send to the entered email address. The connection of the control unit 10 to the user account may then be finalised through user interaction on a remote device 50 by clicking the activation link.

Furthermore a current and/or future weather forecast based on weather condition in the graphical region wherein the control unit 10 is located can be transmitted to the control unit 10 via the web service through the network 44 and displayed on the control unit display 11. This information is provided from an external feed and is inter-connected with general data linked to the user account such as postal address and ZIP code of the building the control unit 10 is located in. Also pricing information may be provided from the web service over network 44.

The remote device 50 is adapted to be located remote from the control unit 10 and can include either or both of: a personal computer (including both a laptop and desktop computer), and a mobile device such as a smart phone, tablet or Personal Digital Assistant (PDA). The remote device 50 and more typically the mobile device may be able to connect to the network 44 over a cellular network. The remote device 50, and most typically the personal computer may connect to network 44 using either a wire-line connection or a wireless connection. The remote device 50 can be loaded with an appropriate browsing application for accessing and browsing the web service via network 44.

With communication interface 65 such as a WLAN module the content of the QR code 26 may be programming control unit data such as control unit settings used to have other control units 10 configured with the same control unit settings. This by the additional possibility of manually entering the control unit settings into the user account using a remote device 50 or a portable reading device 30 wherefrom the control unit settings is transmitted to the other control unit 10.

The content of the QR code 26 may be programming control unit data such as control unit settings used to receive advice on energy saving optimisation of the control unit setting based on regional data from the web service own database 41. The optimisation may include suggestion for control unit settings of one or more of the schedule comfort program, schedule energy saving program and/or any other program in the control unit 10. The relevant control unit setting might in particular include preheating, pre-cooling, open window detection and night-time reduction. Thereby instructing the user in how energy can be saved.

1. A method of communicating control unit data from a control unit of a HVAC system to a portable reading device, the control unit comprising a display, the method comprising;
generating a code based on said control unit data,
converting said code into a graphical layout, and
providing said graphical layout via the display,
wherein, said control unit data comprises dynamic control unit data, and the dynamic control unit data comprises at least environmental control unit data metered by an environmental sensor connected to or comprised within the control unit.

2. The method according to claim 1, wherein said generating comprises compressing and/or encrypting said control unit data.

3. A method of obtaining control unit data with a portable reading device from a control unit of a HVAC system, the method comprising;
scanning a graphical layout,
generating a code based on the graphical layout,
decoding the code by accessing a website, and
obtaining the control unit data based on the decoded code,
wherein, said control unit data comprises dynamic control unit data, and the dynamic control unit data comprises at least environmental control unit data metered by an environmental sensor connected to or comprised within the control unit.

4. The method according to claim 3, wherein said decoding is performed by the website.

5. The method according claim 1, wherein the graphical layout comprises a QR code.

6. (canceled)

7. The method according to claim 1, wherein said control unit data comprises environmental, historical and/or operational control unit data.

8. The method according to claim 1, wherein said control unit data comprises control unit settings.

9. The method according to claim 8, wherein said control unit settings are used to configure one or more control units with the same control unit settings.

10. The method according to claim 3, further comprising converting said control unit data into a usage report.

11. The method according to claim 3, further comprising obtaining regional data from a database via a server 44 and comparing said control unit data with the regional data.

12. A control unit of a HVAC system comprising a display and a processing unit, said control unit is configured to communicate control unit data wherein:
the processing unit is configured to generate a code based on said control unit data, convert said code into a graphical layout, and provide said graphical layout via the display
the display is configured to provide the graphical layout,
said control unit data comprises dynamic control unit data, and
the dynamic control unit data comprises at least environmental control unit data metered by an environmental sensor connected to or comprised within the control unit.

13. The control unit according to claim 12, wherein the graphical layout comprises a QR code.

14. (canceled)

15. A method of communicating control unit data from the control unit according to claim 1, wherein:
the control unit comprises a display and a processing unit, said control unit is configured to communicate control unit data,
the processing unit is configured to generate a code based on said control unit data, convert said code into a graphical layout, and provide said graphical layout via the display,
the display is configured to provide the graphical layout,
said control unit data comprises dynamic control unit data, and
the dynamic control unit data comprises at least environmental control unit data metered by an environmental sensor connected to or comprised within the control unit.

16. A system comprising;
the control unit according to claim 12, and
a portable reading device configured to obtain control unit data form the control unit

17. A non-transitory computer readable medium having a program stored thereon for executing a control unit of a HVAC system to perform a method according to claim 1.

18. A HVAC system comprising;
a control unit according to claim 12, and
a portable reading device configured to obtain control unit data form the control unit.
